(19) United States
(12) Patent Application Publication
(10) Pub. No.: US 2016/0318285 A1
(43) Pub. Date: Nov. 3, 2016

(54) VEHICLE-INTERIOR MATERIAL AND PRODUCTION METHOD THEREFOR

(71) Applicants: SANYO CHEMICAL INDUSTRIES, LTD., Kyoto-shi (JP); TOYOTA JIDOSHA KABUSHIKI KAISHA, Toyota-shi (JP)

(72) Inventors: Shunsuke Kinoshita, Kyoto-shi (JP); Hiroki Hara, Toyota-shi (JP); Yoichi Takagi, Toyota-shi (JP); Daisuke Taniguchi, Toyota-shi (JP)

(73) Assignees: SANYO CHEMICAL INDUSTRIES, LTD., Kyoto-shi (JP); TOYOTA JIDOSHA KABUSHIKI KAISHA, Toyota-shi (JP)

(21) Appl. No.: 15/104,451

(22) PCT Filed: Dec. 16, 2014
(86) PCT No.: PCT/JP2014/006251

§ 371 Date: Jun. 14, 2016

(30) Foreign Application Priority Data
Dec. 24, 2013 (JP) 2013-265083

(51) Int. Cl. B32B 27/06; C08G 18/76; B60R 13/02; C08G 18/48; B32B 7/02; B32B 27/28

(52) U.S. Cl. CPC B32B 27/065; B32B 7/02; B32B 27/285; B60R 13/02; C08G 18/4816; C08G 18/4841; C08G 18/7671; B32B 2266/0278; B32B 2307/536; B32B 2605/003

(57) ABSTRACT

There is provided a vehicle-interior material, and in particular an instrument panel, which is thin, and which imparts a pleasant tactile sensation. In this integrated-urethane foam molded vehicle-interior material, a urethane foam layer is integrally molded between a resin skin material and a base material. The thickness of the urethane foam layer is 2.5-6.0 mm. The urethane foam layer is a foam body formed from a mixed solution comprising: a polyol mixture (P) which includes a polyol (resin) (A), a water-containing foaming agent (C), and a catalyst (D); and a polyisocyanate component (B). The foaming agent (C) content is 1.5-2.5 wt % when the total weight of (A) is used as a reference. The thickness of the resin skin material is 0.6-1.0 mm. The surface of the skin material is displaced at least 0.40 mm by a load of 10N, and is displaced 1.5-2.5 mm by a load of 40N.

### TECHNICAL FIELD

The present invention relates to a vehicle-interior material and a method for producing the vehicle-interior material, more specifically to an integrated-urethane foam molded vehicle-interior material including a resin skin material, a base material and a urethane foam layer integrally molded between the resin skin material and the base material and a method for producing the integrated-urethane foam molded vehicle-interior material.

### BACKGROUND ART

Heretofore, a polyurethane foam has been widely used as a vehicle-interior material such as a crash pad for an instrument panel and others, because of its extremely superior physical properties for use as an impact absorption body and its excellent adhesion to a skin made from vinyl chloride or urethane. In recent years, the demand for reduction in weights of vehicles has been increased for the purpose of enhancing fuel economy, and an instrument panel is no exception. In general, an instrument panel is produced by a method in which a skin and a polypropylene base material are set in a mold and then a urethane foam raw solution is injected between the skin and the base material. In order to spread the urethane foam raw solution throughout the mold, it is required to spread the urethane foam raw solution at a certain level of thickness. If the thickness is reduced (hereinbelow, also referred to as “reduction in thickness”) for the lightweight, the problem that the raw solution cannot flow to end parts of the mold and therefore the filling of the raw solution becomes insufficient occurs. If the viscosity of the raw solution is reduced in order to increase the fluidity of the raw solution, the problem of the hard tactile sensation of the instrument panel occurs.

For example, for the purpose of overcoming these problems, Patent Document 1 proposes a method for improving the tactile sensation of an instrument panel by providing two urethane foam layers having different hardness from each other, and Patent Document 2 proposes a method for improving the tactile sensation of an instrument panel in which a foamed urethane is blown onto a skin in advance and then the resulting product is molded.

However, the method disclosed in Patent Document 1 has the problem that, although the tactile sensation can be improved, the effect induced by the reduction in thickness is small and the production process becomes very complicated. The method disclosed in Patent Document 2 has the problem that, although the tactile sensation can be improved and the thickness can be reduced, a step of blowing the foamed urethane onto the skin is additionally required and therefore the production process becomes complicated.

### PRIOR ART DOCUMENT

### Patent Documents

Patent Document 1: JP-A-2002-240593

Patent Document 2: JP-A-2000-334843

### SUMMARY OF THE INVENTION

### Problems to be Solved by the Invention

An object of the present invention is to provide a vehicle-interior material, particularly an instrument panel, which is thin and has a pleasant tactile sensation.

### Solutions to the Problems

The present inventors have made intensive studies for the purpose of achieving the object. As the result, the present invention has been accomplished.

That is, the present invention provides: an integrated-urethane foam molded vehicle-interior material comprising a resin skin material, a base material and a urethane foam layer integrally molded between the resin skin material and the base material, wherein the urethane foam layer has a thickness of 2.5 to 6.0 mm, the urethane foam layer is a foam body formed from a mixed liquid including a polyol mixture (P) containing a polyol (composition) (A), a water-containing foaming agent (C) and a catalyst (D) and a polyisocyanate component (B), a content of the foaming agent (C) is 1.5 to 2.5% by weight based on a total weight of (A), the resin skin material has a thickness of 0.6 to 1.0 mm, and a skin surface is displaced 0.40 mm or more when a load of 10 N is applied and is displaced 1.5 to 2.5 mm when a load of 40 N is applied; and a method for producing the above-described vehicle-interior material, the method comprising a step of adjusting a cream time to 3 to 5 seconds, a step of adjusting a gel time to 15 to 25 seconds and a step of adjusting a rise time to 25 to 40 seconds when a mixed liquid including the polyol mixture (P) and the polyisocyanate component (B) is foamed and cured at a liquid temperature of 25° C.

### Effects of the Invention

The present invention can provide a vehicle-interior material, particularly an instrument panel, which is thin and has a pleasant tactile sensation.

### MODE FOR CARRYING OUT THE INVENTION

A vehicle-interior material according to the present invention is an integrated-urethane foam molded vehicle-interior material comprising a resin skin material, a base material and a urethane foam layer integrally molded between the resin skin material and the base material, wherein the urethane foam layer has a thickness of 2.5 to 6.0 mm, the urethane foam layer is a foam body formed from a mixed liquid including a polyol mixture (P) containing a polyol (composition) (A), a water-containing foaming agent (C) and a catalyst (D) and a polyisocyanate component (B), a content of the foaming agent (C) is 1.5 to 2.5% by weight based on a total weight of (A), the resin skin material has a thickness of 0.6 to 1.0 mm, and a skin surface is displaced 0.40 mm or more when a load of 10 N is applied and is displaced 1.5 to 2.5 mm when a load of 40 N is applied.

The above-described interior material is thin, has an excellent textile feel, and also has an excellent soft texture and a resilient feel.

It is preferred that the polyol (composition) (A) to be used in the urethane foam layer in the vehicle-interior material according to the present invention contains a polymer polyol (A1) obtained by polymerizing a vinyl monomer in a polyether polyol (a) in the presence of a radical polymerization initiator and/or a polyether polyol (A2), wherein the content of a polymer of the vinyl monomer is 0 to 7% by weight based on the total weight of (A) and the total of (a) and (A2) has an average number of functional groups of 5.5 to 8.

Examples of the polyether polyols (a) and (A2) include ethylene oxide (abbreviated as EO, hereinbelow) and 1,2-propylene oxide (abbreviated as PO, hereinbelow) adducts of compounds containing 2 to 8 or more active hydrogen atoms (a polyhydric alcohol, a polyhydric phenol and an amine), and the like. Two or more of them may be used in combination.

Examples of the polyhydric alcohol include dihydric alcohols having 2 to 12 carbon atoms [ethylene glycol, diethylene glycol, 1,2- and 1,3-propylene glycol, dipropylene glycol, 1,3- and 1,4-butanediol, 1,6-hexanediol, neopentyl glycol, cyclohexanediol and cyclohexanedimethanol, etc.], alcohols having a valency of 3 to 8 or more and having 3 to 12 carbon atoms [glycerol, trimethylolpropane, pentaerythritol, diglycerol, α-methyl glucoside, sorbitol, xylitol, mannitol, glucose, fructose and sucrose, etc.] and combinations of two or more of them.

Examples of the polyhydric phenol include monocyclic polyhydric phenols (pyrogallol and hydroquinone, etc.), bisphenols (bisphenol A, bisphenol F and bisphenol sulfone, etc.), lower condensates of phenol compounds (phenol and cresol, etc.) with formalin (intermediates for novolac resin and resol resin) and combinations of two or more of them.

The amine includes an amine having 2 to 8 or more active hydrogen atoms, and examples of the amine include ammonia; alkanolamines [monoethanolamine, diethanolamine, triethanolamine, isopropanolamine and aminoethylethanolamine, etc.]; alkylamines having 1 to 20 carbon atoms [methylamine, ethylamine, n-butylamine and octylamine, etc.]; alkylenediamines having 2 to 6 carbon atoms [ethylenediamine and hexamethylenediamine, etc.]; polyalkylene polyamines (dialkylenetriamine to hexaalkyleneheptamine in each of which an alkylene group has 2 to 6 carbon atoms) [diethylenetriamine and triethylenetetramine, etc.]; aromatic mono- or polyamines having 6 to 20 carbon atoms [aniline, phenylenediamine, diaminotoluene, xylylenediamine, methylenedianiline and diphenylether diamine, etc.]; alicyclic amines having 4 to 15 carbon atoms [isophoronediamine and cyclohexylenediamine, etc.]; heterocyclic amines having 4 to 15 carbon atoms [aminoethylpiperazine and those described in JP-B-55-21044]; and combinations of two or more of them.

Among them, a polyhydric alcohol is preferred from the viewpoint of the final hardness of a foam constituting the urethane foam layer (also simply referred to as “foam”, hereinbelow) and the liquid flowability of the mixed liquid. A dihydric alcohol having 2 to 4 carbon atoms or a trihydric to octahydric alcohol having 3 to 12 carbon atoms is more preferred.

In the polyether polyols (a) and (A2), the additional method for EO and PO may be either block addition or random addition. It is preferred to carry out the addition of EO and PO by block addition. It is more preferred to add EO to a terminal and optionally to an inner moiety and then carry out the addition of EO by block addition.

The number average molecular weight of each of (a) and (A2) is preferably 3000 to 25000, more preferably 4000 to 20000, and particularly preferably 5000 to 18000, from the viewpoint of the hardness of the foam and the liquid flowability of the mixed liquid.

The % by weight of the EO to be added to each of (a) and (A2) [i.e., the content of the oxyethylene unit (abbreviated as EO unit, hereinbelow)] is preferably 5 to 40%, more preferably 8 to 35%, and particularly preferably 10 to 30% from the viewpoint of the moldability of the foam and the hardness of the foam.

The hydroxyl value (mgKOH/g) of each of (a) and (A2) is preferably 15 to 50, more preferably 20 to 38, and particularly preferably 24 to 35 from the viewpoint of the hardness of the foam and the liquid flowability of the mixed liquid.

In the present invention, the hydroxyl group value is measured in accordance with JIS K-1557-1.

In the present invention, the number average molecular weight is measured by GPC (gel permeation chromatography) under the below-described measurement conditions.

### <Measurement Conditions for GPC>

Column: TSK gel SuperH4000, TSK gel SuperH3000 and TSK gel SuperH2000 (all are manufactured by Tosoh Corporation)

Column temperature: 40° C.

Detector: RI

Solvent: tetrahydrofuran

Flow rate: 0.6 ml/minute

Sample concentration: 0.25%

Injection amount: 10 μl

Standard: polyoxyethylene glycol (manufactured by Tosoh Corporation; TSK STANDARDPOLYETHYLENE OXIDE)

Data processing device: SC-8020 (manufactured by Tosoh Corporation)

The average number of functional groups in each of the polyether polyols refers to an average number of hydroxyl groups contained per molecule of each of the polyether polyols. The average number of functional groups in the total of the polyether polyols (a) and (A2) in the polyol (composition) (A) is preferably 5.5 to 8, and more preferably 6 to 7.5. In the case of a mixture of multiple polyether polyols, for example, even when the number of functional groups in each of the polyether polyols is outside of the range from 5.5 to 8, the average number of functional groups is determined as 5.5 to 8 as long as the weighted average number of functional groups falls within the range from 5.5 to 8. The repulsion elasticity of the foam becomes high when the average number of functional groups is 5.5 or more, and the liquid flowability of the mixed liquid becomes good when the average number of functional groups is 8 or less. The average number of functional groups in each of the polyether polyols can be calculated in accordance with the following formula:

average number of functional groups=[number average molecular weight of polyether polyol]×[hydroxyl value]/56100.

The polymer polyol (A1) in the present invention can be produced by polymerizing a vinyl monomer in the polyether polyol (a) in the presence of a radical polymerization initiator by a conventional manner.

Examples of the vinyl monomer include acrylonitrile, styrene, vinylidene chloride, a (C2-C5)hydroxyalkyl (meth)acrylate and a (C1-C5)alkyl (meth)acrylate, etc. Among them, acrylonitrile and styrene are preferred from the viewpoint of dispersion stability and the hardness of the foam.

The content of the polymer of the vinyl monomer is preferably 0 to 7% by weight based on the total weight of the polyol (composition) (A), and is more preferably 0.5 to 6.5% by weight, and particularly preferably 1 to 6.5% by weight from the viewpoint of the tactile sensation of the vehicle-interior material. When the content is 7% by weight or less, the repulsion elasticity of the foam becomes good.

In the present invention, the radical polymerization initiator that can be used is one that generates a free radical to cause the polymerization to initiate, and examples thereof include azo compounds such as 2,2′-azabisisobutyronitrile, 2,2′-azobis(2,4-dimethylvaleronitrile) and 2,2′-azobis(2-methylbutyronitrile); organic peroxides such as dibenzoyl peroxide, dicumyl peroxide, benzoyl peroxide, lauroyl peroxide and persuccinic acid; and inorganic peroxides such as a persulfuric acid salt and a perboric acid salt. Two or more of them may be used in combination.

A polymer polyol (A11) obtained by polymerizing a vinyl monomer in a polyether polyol (a1) mentioned below in the presence of a radical polymerization initiator is preferable as the polymer polyol (A1) from the viewpoint of hardness:

a polyether polyol (a1): a polyether polyol which is a polyoxyethylene polyoxypropylene polyol and has an average number of functional groups of 2.8 to 4.2, a hydroxyl value of 15 to 38 (mgKOH/g) and a total content of an EO unit of 5 to 40% by weight

The average number of functional groups in (a1) is 2.8 to 4.2, and preferably 3.8 to 4.1.

The hydroxyl value (mgKOH/g) of (a1) is 15 to 38, and preferably 20 to 35 from the viewpoint of the hardness of the foam and the liquid flowability of the mixed liquid.

The total content (% by mass) of the EO unit in (a1) is 5 to 40%, preferably 8 to 35%, and particularly preferably 10 to 30% from the viewpoint of the moldability of the foam and the hardness of the foam.

The number average molecular weight of (a1) is preferably 3000 to 20000, more preferably 4000 to 18000, and particularly preferably 5000 to 16000 from the viewpoint of the hardness of the foam and the liquid flowability of the mixed liquid.

It is preferred that the polyether polyol (A2) contains a polyether polyol (A21) mentioned below from the viewpoint of the amount of displacement of the foam:

a polyether polyol (A21): a polyether polyol which is a polyoxyethylene polyoxypropylene polyol and has an average number of functional groups of 7.8 to 8.2, a hydroxyl value of 20 to 50 (mgKOH/g), a content of a terminal EO of 5 to 25% by weight and a total content of an EO unit of 8 to 30% by weight.

The average number of functional groups in (A21) is 7.8 to 8.2, and preferably 7.9 to 8.1.

The hydroxyl value (mgKOH/g) of (A21) is 20 to 50, and preferably 24 to 35 from the viewpoint of the hardness of the foam and the liquid flowability of the mixed liquid.

The content (% by mass) of the terminal EO unit in (A21) is 5 to 25%, preferably 8 to 22%, and particularly preferably 10 to 20% from the viewpoint of the moldability of the foam and the hardness of the foam.

The total content (% by mass) of the EO unit in (A21) is 8 to 30%, preferably 8 to 25%, and particularly preferably 10 to 20% from the viewpoint of the moldability of the foam and the hardness of the foam.

The number average molecular weight of (A21) is preferably 5000 to 25000, more preferably 8000 to 20000, and particularly preferably 12000 to 18000 from the viewpoint of the hardness of the foam and the liquid flowability of the mixed liquid.

In the present invention, the polyol (composition) (A) may be a single polyol or a mixture of two or more polyols.

The polyol (composition) (A) in the present invention may be the polymer polyol (A1) alone, the polyether polyol (A2) alone, or a mixture of (A1) and (A2). From the viewpoint of the liquid flowability of the mixed liquid, (A2) alone and the mixture of (A1) and (A2) are preferred, and the mixture of (A1) and (A2) is more preferred. Particularly preferably, the polyol (composition) (A) contains said polyether polyol (A21) and the polymer polyol (A11), wherein the content of (A21) and that of (A11) in (A) are 70 to 90% by weight and 5 to 25% by weight, respectively.

The polyisocyanate component (B) to be used in the urethane foam layer in the vehicle-interior material according to the present invention may be a polyisocyanate that is generally used for the production of polyurethane. For the reasons of improvement in productivity, improvement in a working environment and the like, the polyisocyanate component (B) preferably contains one or more compounds selected from the group of diphenylmethane diisocyanate, polymethylene polyphenylene polyisocyanate and modified products thereof. Examples of the above-described modified products include urethane-modified products, carbodiimide-modified products, allophanate-modified products, urea-modified products, biuret-modified products, isocyanurate-modified products and oxazolidone-modified products, etc.

An NCO content in (B) is preferably 20 to 30% by weight, and more preferably 22 to 29% from the viewpoint of the hardness and repulsion elasticity of the foam and the liquid flowability of the mixed liquid. The liquid flowability of the mixed liquid becomes good when the NCO content is 20% or more, and the hardness of the foam is decreased and the repulsion elasticity of the foam is improved when the NCO content is 30% or less.

The foaming agent (C) to be used in the urethane foam layer in the vehicle-interior material according to the present invention contains water as an essential component and if necessary contains other foaming agent in combination. From the viewpoint of moldability, the content of water is preferably 20 to 100% by weight, more preferably 50 to 100% by weight, and particularly preferably 100% by weight based on the weight of the component (C).

Examples of other foaming agent include a liquefied carbon dioxide gas and a low-boiling compound having a boiling point of −5 to 70° C.

Examples of the low-boiling compound include a hydrogen atom-containing halogenated hydrocarbon and a low-boiling hydrocarbon, etc. Specific examples of the hydrogen atom-containing halogenated hydrocarbon and the low-boiling hydrocarbon include HCFC (hydrochlorofluorocarbon) (HCFC-123, HCFC-141b and HCFC-142b, etc.); HFC (hydrofluorocarbon) (HFC-152a, HFC-356mff, HFC-236ea, HFC-245ca, HFC-245fa and HFC-365mfc, etc.), butane, pentane and cyclopentane, etc.

The content of the foaming agent (C) is 1.5 to 2.5% by weight based on the weight of the polyol (composition) (A). From the viewpoint of the moldability of the foam, the content is preferably 1.6 to 2.2% by weight, and more preferably 1.7 to 2.1% by weight. If the content of (C) is less than 1.5% by weight, the liquid flowability of the foam is lowered. If the content of (C) is more than 2.5% by weight, the moldability of the foam is deteriorated.

The catalyst (D) to be used in the urethane foam layer in the vehicle-interior material according to the present invention can be a catalyst that accelerates any urethanization reaction common in the art. Examples of the catalyst (D) can include amine-type catalysts such as triethylenediamine, triethylamine, triethanolamine, bis(N,N-dimethylaminoethyl) ether, N,N-dimethylaminopropyldipropanolamine, N,N,N′,N′-tetramethylhexamethylenediamine and “KAOLIZER P-200” manufactured by Kao Corporation; organic metal compounds such as a carboxylic acid metal salt and dibutyltin laurate; and carboxylic acid metal salts such as potassium acetate, potassium octylate and stannous octoate. When the above-described catalyst is used in the mixed liquid comprising the polyol mixture (P) and the polyisocyanate component (B), the condensation reaction in the polyurethane formation can be controlled in a proper state.

The amount of the catalyst (D) to be used is preferably 1.0 to 3.5% by weight, and more preferably 1.5 to 3.0% by weight based on the weight of the polyol (composition) (A) from the viewpoint of the moldability of the foam.

In the present invention, if necessary, a foam stabilizer (E) can be contained in the polyol mixture (P). The foam stabilizer (E) may be any one that can be used in the production of conventional polyurethane foams, and examples thereof include dimethyl siloxane-type foam stabilizers [“SRX-253”, “PRX-607” manufactured by Dow Corning Toray Co., Ltd., etc.] and polyether-modified dimethyl siloxane-type foam stabilizers [“SZ-1142”, “SRX-294A”, “SH-193”, “SZ-1720”, “SZ-1675t”, “SF-2936F” and the like manufactured by Dow Corning Toray Co., Ltd., “L-3640” and the like manufactured by Momentive Performance Materials Inc., and “B-8715LF2” and the like manufactured by Degussa Japan Co., Ltd.]. The amount of the foam stabilizer to be used is preferably 0.1 to 5.0% by weight, and more preferably 0.5 to 1.0% by weight based on the weight of the polyol (composition) (A) from the viewpoint of the moldability of the foam and the discoloration of the foam.

In the present invention, if necessary, a cross-linking agent (F) can be contained in the polyol mixture (P). The cross-linking agent (F) may be any one that can be used for the production of conventional polyurethane foams, and examples thereof include a polyhydric alcohol, a polyhydric phenol and an amine. Examples of the polyhydric alcohol include dihydric alcohols having 2 to 12 carbon atoms [ethylene glycol, diethylene glycol, propylene glycol, dipropylene glycol, 1,4-butanediol, 1,6-hexanediol, 1,3-butylene glycol, diethylene glycol and neopentyl glycol, etc.] and alcohols having a valency of 3 to 8 or more and having 3 to 12 carbon atoms [glycerol, trimethylolpropane, pentaerythritol, diglycerol, α-methyl glucoside, sorbitol, xylitol, mannitol, glucose, fructose and sucrose, etc.], and the like.

Examples of the polyhydric phenol include monocyclic polyhydric phenols (hydroquinone etc.), bisphenols (bisphenol A, bisphenol F, etc.) and lower condensates of phenol compounds (phenol and cresol, etc.) with formalin (intermediates for novolac resin and resol resin), and the like.

Examples of the amine includes alkanolamines [monoethanolamine, diethanolamine, triethanolamine, isopropanolamine and aminoethylethanolamine, etc.]; alkylamines having 1 to 20 carbon atoms [methylamine, ethylamine, n-butylamine and octylamine, etc.]; alkylenediamines having 2 to 6 carbon atoms [ethylenediamine and hexamethylenediamine, etc.]; polyalkylene polyamines (dialkylenetriamine to hexaalkyleneheptamine in each of which an alkylene group has 2 to 6 carbon atoms) [diethylenetriamine and triethylenetetramine, etc.]; aromatic mono- or polyamines having 6 to 20 carbon atoms [aniline, phenylenediamine, diaminotoluene, xylylenediamine, methylenedianiline and diphenylether diamine, etc.]; alicyclic amines having 4 to 15 carbon atoms [isophoronediamine and cyclohexylenediamine, etc.]; heterocyclic amines having 4 to 15 carbon atoms [aminoethylpiperazine and those described in JP-B-55-21044, etc.]; combinations of two or more of them, and the like.

From the viewpoint of the curability of the foam, an amine is preferred.

In the present invention, if necessary, conventionally known additives and aids can be used in the polyol mixture (P), including anti-aging agents such as antioxidant agents (hindered phenol and hindered amine, etc.) and ultraviolet ray absorbers (triazole and benzophenone, etc.); fillers such as inorganic salts (calcium carbonate and barium sulfate, etc.), inorganic fibers (glass fibers and carbon fibers, etc.) and whiskers (potassium titanate whiskers, etc.); flame retardant agents (phosphoric acid ester, etc.); adhesive agents (modified polycaprolactone polyol, etc.); plasticizers (phthalic acid ester, etc.); coloring agents (dye and pigment); antibacterial agents; anti-fungal agents; and the like.

In the present invention, the isocyanate index [(NCO group/active hydrogen atom-containing groups) equivalent ratio×100] of a mixed liquid composed of the polyol mixture (P) and the polyisocyanate component (B) is preferably 70 to 140, more preferably 75 to 130, and particularly preferably 80 to 120 from the viewpoint of the curability of the foam and the moldability of the foam.

In the integrated-urethane foam molded vehicle-interior material including the urethane foam layer according to the present invention, when the molding is carried out employing a thickness of the urethane foam layer of 2.5 to 6.0 mm and a thickness of the resin skin material of 0.6 to 1.0 mm, a molded product (vehicle-interior material) is obtained in which the surface of the skin is displaced 0.40 mm or more, preferably 0.40 to 1.5 mm when a load of 10 N is applied and is displaced 1.5 to 2.5 mm when a load of 40 N is applied.

The resin skin material and the method for molding the resin skin material are not particularly limited, as long as the resulting product can be used as a vehicle-interior material. From the viewpoint of the moldability and the workability, it is preferred that the resin skin material is produced by slush molding of a thermoplastic resin.

Examples of the thermoplastic resin include a vinyl chloride resin, a urethane (urea) resin, an acrylic resin, an ABS resin, a polyamide, a polyester, a polycarbonate, a polyethylene, a polypropylene, a polystyrene and a mixture of two or more of them. Among them, a vinyl chloride resin and a urethane (urea) resin are preferred, and a urethane (urea) resin is particularly preferred from the viewpoint of the soft feel of the slush-molded product.

The surface of the resin skin material in the vehicle-interior material has a C hardness of preferably 42 to 50, and more preferably 43 to 49 from the viewpoint of the tactile sensation.

The ball rebound of the vehicle-interior material according to the present invention is preferably 33% or more, and more preferably 34 to 40%.

One example of the method for producing the vehicle-interior material according to the present invention is as follows.

First, predetermined amounts of the polyol (composition) (A), the foaming agent (C) and the catalyst (D) as well as optionally the other additive or aid are mixed together to prepare the polyol mixture (P).

Subsequently, the polyol mixture (P) is quickly mixed with the polyisocyanate component (B) with a polyurethane foaming machine (low-pressure or high-pressure foaming machine, preferably high-pressure foaming machine) or a stirrer. The resulting mixed liquid is injected into a close injection type-crash pad mold (preferably having a mold temperature of 25 to 50° C.) in which a resin skin material and a base material are set respectively on both surfaces thereof, foamed and cured in the mold, and then demolded after a predetermined period of time to obtain a vehicle-interior material having a uniform density distribution. The additive, the aid or the like may be mixed with the polyisocyanate component (B) upon use. The filling rate during the injection [(density during mold foaming/density during free foaming)×100] is preferably 100 to 400%, and particularly preferably 150 to 350%.

The method for producing a vehicle-interior material according to the present invention includes a step of adjusting a cream time to 3 to 5 seconds, a step of adjusting a gel time to 15 to 25 seconds and a step of adjusting a rise time to 25 to 40 seconds when the mixed liquid of the polyol mixture (P) and the polyisocyanate component (B) is foamed and cured at a liquid temperature of 25° C.

According to the production method of the present invention, a vehicle-interior material which exhibits good liquid flowability during molding and which is thin and has a pleasant tactile sensation can be obtained.

In the production method according to the present invention, for adjusting the cream time, the gel time and the rise time, for example, the amount of the catalyst (D) to be used should be adjusted. For promoting the cream time and the rise time, the amount of an amine-type catalyst, preferably bis(N,N-dimethylaminoethyl) ether or N,N-dimethylaminopropyldipropanolamine to be used should be increased. For promoting the gel time, the amount of an amine-type catalyst and/or an organic metal compound, preferably a tertiary amine catalyst [“KAOLIZER P-200” manufactured by Kao Corporation, triethylenediamine, etc.] to be used should be increased.

Even when it is confirmed that the cream time, the gel time and the rise time respectively fall with the above-described ranges and there is no need to prolong or shorten each of the times, the confirmation of each of the times is deemed to have the adjustment step

### EXAMPLES

Hereinbelow, the present invention will be described more in detail by way of examples. However, the present invention is not limited thereby. Hereinbelow, part(s) and % refer to part(s) by weight and % by weight, respectively, unless otherwise specified.

### Examples 1 to 11 and Comparative Examples 1 to 2

A polyol mixture (P) and a polyisocyanate component (B) shown in Tables 1 and 2 were mixed together with a high-pressure foaming machine (MiniRIM machine, manufactured by PEC), and the resulting mixture was injected into a metal closed mold having a size of 100×1200×6.1 to 10 mm for molding. In the mold, a polyurethane skin having a thickness of 0.6 to 1.0 mm and a polypropylene base material having a thickness of 3 mm were set in advance on both surfaces of the mold, respectively. The molding conditions are as follows.

### <Molding Conditions>

Liquid temperature: (P)/(B)=25° C./25° C.

Mold temperature: 40° C.

Curing time: 60 seconds

The measurement results of the moldability and physical properties of each of the foams thus obtained are shown in Tables 1 and 2.

In Tables 1 and 2, the charge amount of each material used is shown by part(s) by weight. The charge amount of each polyisocyanate component is shown by isocyanate index.

TABLE 1

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Polyol | Polyol | (A2-1) | 75 | 75 | 75 | 75 | 75 | 80 | 100 | 40 | 75 | 75 | 70 |
| mixture | (composition) | (A2-2) | 12 | 12 | 12 | 12 | 12 | | | 60 | 12 | 12 | 17 |
| (P) | (A) | (a-1) | | | | | | | | | | | |
| | | (A1-1) | 13 | 13 | 13 | 13 | 13 | 20 | | | 13 | 13 | 13 |
| | Foaming agent | Water | 2.0 | 2.0 | 2.0 | 2.0 | 2.0 | 2.0 | 2.0 | 2.0 | 2.0 | 2.0 | 2.0 |
| | (C) | | | | | | | | | | | | |
| | Catalyst (D) | (D-1) | 2.0 | 2.0 | 2.0 | 2.0 | 2.0 | 2.0 | 2.0 | 2.0 | 2.0 | 2.0 | 2.0 |
| | | (D-2) | 0.5 | 0.5 | 0.5 | 0.5 | 0.5 | 0.5 | 0.5 | 0.5 | 0.5 | 0.5 | 0.5 |
| | Foam stabilizer | (E-1) | 0.5 | 0.5 | 0.5 | 0.5 | 0.5 | 0.5 | 0.5 | 0.5 | 0.5 | 0.5 | 0.5 |
| | (E) | | | | | | | | | | | | |

| Polyisocyanate | (B-1) | 100 | 100 | 100 | 100 | 100 | 100 | 100 | 100 | | | 100 |
|---|---|---|---|---|---|---|---|---|---|---|---|---|
| component (B) | (Index) | | | | | | | | | | | |
| | (B-2) | | | | | | | | | 100 | | |
| | (Index) | | | | | | | | | | | |
| | (B-3) | | | | | | | | | | 100 | |
| | (Index) | | | | | | | | | | | |
| Average number of functional groups in total | | 6.0 | 6.0 | 6.0 | 6.0 | 6.0 | 7.0 | 8.0 | 3.9 | 6.0 | 6.0 | 5.6 |
| of (a) and (A2) in (A) | | | | | | | | | | | | |
| Content of polymer in (A) (%) | | 3.9 | 3.9 | 3.9 | 3.9 | 3.9 | 6.0 | 0.0 | 0.0 | 3.9 | 3.9 | 3.9 |
| Thickness (mm) | Urethane foam | 2.5 | 2.5 | 3.5 | 6.0 | 6.0 | 3.5 | 3.5 | 3.5 | 3.5 | 3.5 | 3.5 |
| | layer | | | | | | | | | | | |
| | Resin skin | 0.6 | 1.0 | 0.8 | 0.6 | 1.0 | 0.8 | 0.8 | 0.8 | 0.8 | 0.8 | 0.8 |
| | material | | | | | | | | | | | |
| <Reactivity (sec)> | Cream time | 3 | 3 | 3 | 3 | 3 | 3 | 3 | 3 | 5 | 5 | 3 |
| | Gel time | 21 | 21 | 21 | 21 | 21 | 22 | 21 | 23 | 23 | 23 | 23 |
| | Rise time | 27 | 27 | 27 | 27 | 27 | 27 | 27 | 27 | 33 | 33 | 25 |
| <Moldability> | Liquid flowability | ⊙ | ⊙ | ⊙ | ⊙ | ⊙ | ◯ | ◯ | ◯ | Δ | Δ | ◯ |
| | Curability | ◯ | ◯ | ◯ | ◯ | ◯ | ◯ | ◯ | Δ | ◯ | ◯ | Δ |
| <Amount of | Load: 10 N | 0.60 | 0.40 | 0.45 | 0.40 | 0.40 | 0.40 | 0.50 | 0.60 | 0.45 | 0.40 | 0.45 |
| displacement of | Load: 40 N | 2.2 | 1.8 | 2.0 | 2.3 | 1.8 | 2.0 | 2.1 | 2.2 | 2.0 | 2.3 | 2.3 |
| skin surface (mm)> | | | | | | | | | | | | |
| <Physical properties of | Whole density | 0.22 | 0.22 | 0.22 | 0.22 | 0.22 | 0.22 | 0.22 | 0.22 | 0.22 | 0.22 | 0.22 |
| foam> | C hardness | 42 | 48 | 45 | 42 | 48 | 48 | 43 | 43 | 49 | 48 | 46 |
| | Ball rebound (%) | 35 | 38 | 37 | 35 | 38 | 33 | 37 | 30 | 31 | 31 | 30 |

TABLE 2

| | | | Comparative | |
|---|---|---|---|---|
| | | | Example | |
| | | | 1 | 2 |
| Polyol | Polyol | (A2-1) | 75 | 75 |
| mixture | (composition) | (A2-2) | 12 | 12 |
| (P) | (A) | (a-1) | | |
| | | (A1-1) | 13 | 13 |
| | Foaming agent (C) | Water | 1.4 | 2.6 |
| | Catalyst (D) | (D-1) | 2.0 | 2.0 |
| | | (D-2) | 0.5 | 0.5 |
| | Foam stabilizer | (E-1) | 0.5 | 0.5 |
| | (E) | | | |

| Polyisocyanate component (B) | (B-1) | 100 | 100 |
|---|---|---|---|
| | (Index) | | |
| Average number of functional groups in total of | | 6.0 | 6.0 |
| (a) and (A2) in (A) | | | |
| Content of polymer in (A) (%) | | 3.9 | 3.9 |
| Thickness (mm) | Urethane foam layer | 3.5 | 3.5 |
| | Resin skin material | 0.8 | 0.8 |
| <Reactivity (sec)> | Cream time | 2 | 5 |
| | Gel time | 25 | 19 |
| | Rise time | 33 | 27 |
| <Moldability> | Liquid flowability | X | Δ |
| | Curability | X | ◯ |
| <Amount of displacement of | Load: 10 N | 0.55 | 0.30 |
| skin surface (mm)> | Load: 40 N | 2.0 | 1.8 |
| <Physical properties of | Whole density | 0.22 | 0.22 |
| foam> | C hardness | 35 | 55 |
| | Ball rebound (%) | 35 | 33 |

The components shown in Tables 1 and 2 are as follows.

(A2-1): block adduct in which PO and EO are added in this order to sucrose (average number of functional groups: 8.0, hydroxyl value: 28, content of terminal EO unit=20%).

(A2-2): block adduct in which PO and EO are added in this order to glycerol (average number of functional groups: 3.0, hydroxyl value: 34, content of terminal EO unit=20%).

(a-1): block adduct in which PO and EO are added in this order to pentaerythritol (average number of functional groups: 4.0, hydroxyl value: 28, content of terminal EO unit=14%).

(A1-1): polymer polyol obtained by copolymerizing acrylonitrile and styrene in the polyol (a-1) (polymer content: 30%, acrylonitrile/styrene ratio (by weight)=65/35).

(B-1): modified MDI [“CEF-263”, manufactured by Nippon Polyurethane Industry Co., Ltd., NCO content=28.7%].

(B-2): modified MDI [“CEI-264”, manufactured by Nippon Polyurethane Industry Co., Ltd., NCO content=30.4%].

(B-3): polymeric MDI [“MR-200”, manufactured by Nippon Polyurethane Industry Co., Ltd., NCO content=31.3%].

(D-1): tertiary amine catalyst [“KAOLIZER P-200”, manufactured by Kao Corporation].

(D-2): 70% solution of bis(N,N-dimethylamino-2-ethyl) ether in diethylene glycol [“TOYOCAT-ET”, manufactured by Tosoh Corporation].

(E-1): organic modified polysiloxane mix [“Tegostab B8715LF2”, manufactured by Degussa Japan Co., Ltd.].

### <Reactivity>

The methods for evaluating reactivity are as follows.

Cream time: a time (second(s)) between a time point at which raw materials [polyol mixture (P) and polyisocyanate component (B)] are injected and a time point at which foaming starts when the raw materials are free-foamed in a wood box having a size of 20 cm×20 cm×30 cm at a liquid temperature of the raw materials immediately before urethanization reaction of 25° C. in the urethanization reaction.

Gel time: a (resin formation) time (second(s)) between a time point at which mixing of the polyol mixture (P) with the polyisocyanate component (B) starts and a time point at which the mixture begins to become thick to develop gel strength.

Rise time: a time (second(s)) between a time point at which mixing of the polyol mixture (P) with the polyisocyanate component (B) starts and a time point at which an increase in an expanded foam is terminated.

### <Moldability>

The methods for evaluating moldability are as follows.

Liquid flowability: the appearance of the foam that was demolded from the mold was confirmed and was rated in accordance with the following criteria.

x: underfill portion is present

Δ: voids or deformed cells are present at end part of molded product.

◯: almost no void or deformed cell is present at end part of molded product

(area in which voids or deformed cells are present is 1 to 5%).

⊙: no void or deformed cell is present in at end part of molded product

(area in which voids or deformed cells are present is less than 1%).

Curability: the foam was removed from the mold, then a load of 5 kg was applied to the foam for 3 seconds, and then the degree of deformation of the foam was confirmed and rated in accordance with the following criteria.

x: deformation of 5 mm or more and less than 10 mm is observed.

Δ: deformation of 1 mm or more and less than 5 mm is observed.

◯: deformation of less than 1 mm is observed.

### <Amount of Displacement>

The skin surface of a test piece was pressed with a circular pressurizing plate having a diameter of 14 mm at a rate of 50 mm/minute using a compressive load testing machine equipped with an automated recording device (Autograph AG-1 20 kN manufactured by Shimadzu Corporation), and the amounts (mm) of displacement of the skin surface for which the load became 10 N and 40N were measured.

### <Physical Properties of Foam>

The methods for evaluating physical properties of a foam are as follows.

Whole density (g/cm³): JIS K6401 (whole density refers to “apparent density” as defined in the JIS standard).

C hardness: C hardness was measured with Asker C hardness meter (“Asker rubber hardness meter type-C”, manufactured by Kobunshi Keiki Co, Ltd.)

Ball rebound: the surface of a resin skin material was measured in accordance with the method of JIS K6401.

Examples 1 to 11 have superior liquid flowability and curability compared with those of Comparative Examples 1 and 2, and vehicle-interior materials respectively produced using the products of Examples 1 to 11 are thin and have a soft texture and a resilient feel and also have an excellent tactile sensation. Examples 1 to 7 are particularly good.

### INDUSTRIAL APPLICABILITY

The vehicle-interior material according to the present invention is thin and has a soft texture, a resilient feel and an excellent tactile sensation, and therefore can be used widely as a vehicle-interior material such as a crash pad for an instrument panel and others.

1. An integrated-urethane foam molded vehicle-interior material comprising a resin skin material, a base material and a urethane foam layer integrally molded between the resin skin material and the base material, wherein
the urethane foam layer has a thickness of 2.5 to 6.0 mm,
the urethane foam layer is a foam body formed from a mixed liquid including a polyol mixture (P) containing a polyol (composition) (A), a water-containing foaming agent (C) and a catalyst (D) and a polyisocyanate component (B),
a content of the foaming agent (C) is 1.5 to 2.5% by weight based on a total weight of (A),
the resin skin material has a thickness of 0.6 to 1.0 mm, and
a skin surface is displaced 0.40 mm or more when a load of 10 N is applied and is displaced 1.5 to 2.5 mm when a load of 40 N is applied.

2. The vehicle-interior material according to claim 1, wherein the polyol (composition) (A) contains a polymer polyol (A1) obtained by polymerizing a vinyl monomer in a polyether polyol (a) in the presence of a radical polymerization initiator and/or a polyether polyol (A2), a content of a polymer of the vinyl monomer is 0 to 7% by weight based on a total weight of (A), and a total of (a) and (A2) has an average number of functional groups of 5.5 to 8, and wherein the polyisocyanate component (B) contains one or more compounds selected from the group of diphenylmethane diisocyanate, polymethylene polyphenylene polyisocyanate and modified products thereof and an NCO content in (B) is 20 to 30% by weight.

3. The vehicle-interior material according to claim 2, wherein the polymer polyol (A1) contains a polymer polyol (A11) obtained by polymerizing a vinyl monomer in a polyether polyol (a1) mentioned below in the presence of a radical polymerization initiator, the polyether polyol (A2) contains a polyether polyol (A21) mentioned below, and a content of (A11) and a content of (A21) in (A) are 5 to 25% by weight and 70 to 90% by weight, respectively:
a polyether polyol (a1): a polyether polyol which is a polyoxyethylene polyoxypropylene polyol and has an average number of functional groups of 2.8 to 4.2, a hydroxyl value of 15 to 38 (mgKOH/g) and a total content of an oxyethylene unit of 5 to 40% by weight; and
a polyether polyol (A21): a polyether polyol which is a polyoxyethylene polyoxypropylene polyol and has an average number of functional groups of 7.8 to 8.2, a hydroxyl value of 20 to 50 (mgKOH/g), a content of a terminal oxyethylene unit of 5 to 25% by weight and a total content of an oxyethylene unit of 8 to 30% by weight.

4. The vehicle-interior material according to claim 1, wherein a surface of the resin skin material in the vehicle-interior material has a C hardness of 42 to 50 and a ball rebound of 33% or more.

5. The vehicle-interior material according to claim 1, wherein the resin skin material is produced by slush molding of a thermoplastic resin.

6. A method for producing the vehicle-interior material according to claim 1, the method comprising:
a step of adjusting a cream time to 3 to 5 seconds;
a step of adjusting a gel time to 15 to 25 seconds; and
a step of adjusting a rise time to 25 to 40 seconds when a mixed liquid including the polyol mixture (P) and the polyisocyanate component (B) is foamed and cured at a liquid temperature of 25° C.
